(19) United States
(12) Patent Application Publication
(10) Pub. No.: US 2008/0269401 A1
(43) Pub. Date: Oct. 30, 2008

(54) Polymer Alloy Composition

(75) Inventors: Bong Jae LEE, Uiwang-si (KR); Sung Sig MIN, Uiwang-si (KR); Tae Gon KANG, Uiwang-si (KR); Jong Cheol LIM, Uiwang-si (KR)

Correspondence Address: SUMMA, ALLAN & ADDITON, P.A., 11610 NORTH COMMUNITY HOUSE ROAD, SUITE 200, CHARLOTTE, NC, 28277, US

(73) Assignee: CHEIL INDUSTRIES INC., Gumi-si (KR)

(21) Appl. No.: 12/164,304

(22) Filed: Jun. 30, 2008

Related U.S. Application Data
(63) Continuation-in-part of application No. PCT/KR2006/005819, filed on Dec. 28, 2006.

(30) Foreign Application Priority Data
Dec. 29, 2005 (KR) 10-2005-0132960
Dec. 20, 2006 (KR) 10-2006-0131391

(51) Int. Cl. C08L 67/00; C08L 51/08; C08L 51/04

(52) U.S. Cl. 524/539; 525/418; 525/63; 525/64

(57) ABSTRACT

Provided is a polymer alloy composition having excellent fatigue resistance, impact resistance and chemical resistance. The composition comprises about 30 to about 80% by weight of a polycarbonate resin, about 20 to about 70% by weight of a polyester resin having an intrinsic viscosity of about 1.2 to about 2, and about 0.5 to about 20 parts by weight of an impact modifier, based on about 100 parts by weight of the polycarbonate resin and the polyester resin.

### CROSS-REFERENCE TO RELATED APPLICATIONS

This application is a continuation-in-part application of PCT Application No. PCT/KR2006/005819, filed Dec. 28, 2006, pending, which designates the U.S. and which is hereby incorporated by reference in its entirety, and claims priority therefrom under 35 USC Section 120. This application also claims priority under 35 USC Section 119 from Korean Patent Application No. 10-2005-0132960, filed Dec. 29, 2005, and Korean Patent Application No. 10-2006-0131391, filed Dec. 20, 2006, both of which are also hereby incorporated by reference in their entirety.

### FIELD OF THE INVENTION

The present invention relates to a polymer alloy composition.

### BACKGROUND OF THE INVENTION

Polycarbonate/polyester polymer alloy compositions have been widely used in the production of parts and components for motor vehicles and electronic products, because of their chemical resistance, high fluidity and high impact strength.

Upon polymer-alloying of a polycarbonate resin into a polyester resin, the resulting polymer alloy composition exhibits excellent overall physical properties such as enhanced chemical resistance due to the polyester resin while maintaining excellent impact resistance possessed by polycarbonate resin.

However, the polycarbonate/polyester polymer alloy resin can suffer from problems associated with significant phase separation during extrusion and injection processes due to the difference between the fluidity of the polycarbonate resin and the polyester resin. Phase separation can result in deterioration of basic physical properties including impact resistance.

Such problems influence working conditions during the extrusion and injection processes, and thereby function as limiting factors in expansion of applications for the polycarbonate/polyester polymer alloy.

### SUMMARY OF THE INVENTION

In accordance with an aspect of the present invention, there is provided a polymer alloy composition which can comprise about 30 to about 80% by weight of a polycarbonate resin, about 20 to about 70% by weight of a polyester resin having an intrinsic viscosity of about 1.2 to about 2, and about 0.5 to about 20 parts by weight of an impact modifier, based on about 100 parts by weight of the polycarbonate resin and the polyester resin.

The inventors have found that the use of the high-viscosity polyester resin with an intrinsic viscosity of about 1.2 to about 2 in the composition can promote the formation of nano-sized (nano-scale) polycarbonate and polyester phases in the composition. In exemplary embodiments of the invention, the polyester resin and the polycarbonate resin can have a phase size ranging from about 10 nanometers (nm) to about 200 nm. The composition can further exhibit substantially uniform polymer phase dispersion. The nano-sized polymer phases and uniform phase dispersion can improve the dispersibility of the impact modifier in the composition. These factors can also minimize phase separation during polymer processing. The polymer alloy composition of the present invention can accordingly exhibit excellent fatigue resistance, impact resistance and chemical resistance.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a photograph showing morphological analysis of a resin composition of Example 3, using transmission electron microscopy (TEM); and

FIG. 2 is a photograph showing morphological analysis of a resin composition of Comparative Example 4, using transmission electron microscopy (TEM).

### DETAILED DESCRIPTION OF THE INVENTION

The present invention now will be described more fully hereinafter in the following detailed description of the invention, in which some, but not all embodiments of the invention are described. Indeed, this invention may be embodied in many different forms and should not be construed as limited to the embodiments set forth herein; rather, these embodiments are provided so that this disclosure will satisfy applicable legal requirements.

A polymer alloy composition according to an exemplary embodiment of the present invention comprises about 30 to about 80% by weight of a polycarbonate resin, about 20 to about 70% by weight of a polyester resin having an intrinsic viscosity of about 1.2 to about 2, and about 0.5 to about 20 parts by weight of an impact modifier, based on about 100 parts by weight of the polycarbonate resin and the polyester resin.

The polycarbonate resin in the polymer alloy composition of the present invention can have a molecular structure represented by Formula I below, and can be prepared by reaction of a dihydric alcohol, such as a bisphenol having a molecular structure of Formula II below, with phosgene in the presence of a molecular weight modifier and a catalyst, or can be prepared by transesterification of a dihydric alcohol, such as a bisphenol, with a carbonate precursor such as diphenylcarbonate. Examples of the polycarbonate compounds may include linear polycarbonates, branched polycarbonates, polyester carbonate copolymers, silicone-polycarbonate copolymers, and the like, and combinations thereof.

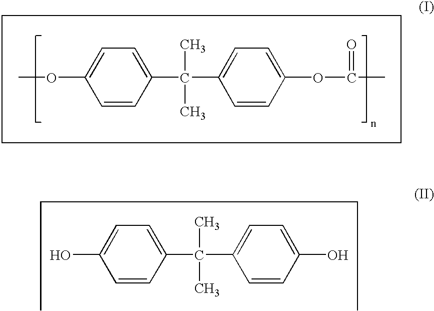

An exemplary dihydric phenol that can be used to prepare the polycarbonate resin is 2,2-bis(4-hydroxyphenyl)propane (Bisphenol A) of Formula (II) above. Bisphenol A may be partially or completely replaced with another dihydric phenol. Examples of dihydric phenols useful in the present invention other than Bisphenol A may include, but are not limited to, hydroquinone, 4,4′-dihydroxydiphenyl, bis(4-hydroxyphenyl)methane, 1,1-bis(4-hydroxyphenyl)cyclohexane, 2,2-bis(3,5-dimethyl-4-hydroxyphenyl)propane, bis(4-hydroxyphenyl)sulfide, bis(4-hydroxyphenyl)sulfone, bis(4-hydroxyphenyl)sulfoxide, bis(4-hydroxyphenyl)ketone, bis(4-hydroxyphenyl)ether, halogenated bisphenols such as 2,2-bis(3,5-dibromo-4-hydroxyphenyl)propane, and the like, and combinations thereof.

The polycarbonate resin may be a homopolymer, a copolymer of two or more bisphenols, or a mixture thereof.

The linear polycarbonate resin can be a Bisphenol A-based polycarbonate resin.

The branched polycarbonate may be prepared by the reaction of a multi-functional aromatic compound such as trimellitic anhydride or trimellitic acid with dihydroxyphenol and a carbonate precursor.

The polyester carbonate copolymer may be prepared by reaction of di-functional carboxylic acid with dihydric phenol and a carbonate precursor.

The polymer alloy composition of the present invention can include the polycarbonate resin in an amount of about 30 to about 80% by weight.

When the content of the polycarbonate resin is lower than about 30% by weight, the polycarbonate phase can be a discontinuous phase, which may result in deterioration of impact resistance. On the other hand, when the content of the polycarbonate resin is higher than about 80% by weight, the dispersibility of the polyester resin is lowered, which may result in deterioration of chemical resistance and fatigue resistance.

The polyester resin used in the present invention can have an intrinsic viscosity of about 1.2 or higher, for example about 1.2 to about 2, and can have a structure represented by Formula III below:

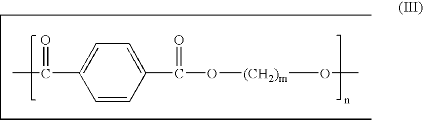

wherein m is an integer of 2 to 4, and n is an integer of 50 to 300.

The polyester may be prepared according to the following procedure.

First, an acid component, a glycol component, a catalyst and various additives including a stabilizing agent are introduced into a stainless steel reaction vessel equipped with a stirrer. An ester reaction is allowed to proceed simultaneously with removal of the resulting ester condensation by-products having a low molecular weight from the reaction system while maintaining the reaction vessel at a temperature of about 200° C. to about 230° C. The ester reaction is terminated based on the point in time at which more than about 95% of a theoretical amount of the low-molecular weight ester by-products produced in the ester reaction is discharged from the reaction system.

Upon completion of the ester reaction, the reaction vessel temperature is elevated to a range of about 250° C. to about 280° C. and the reaction vessel pressure is simultaneously reduced to less than about 1 mm Hg, to thereby induce polycondensation of the polyester.

The polycondensation reaction is allowed to proceed as above and terminated upon reaching a moderate stirring load. Thereafter, the vacuum condition of the reaction system is released by a nitrogen purge and the reaction product is discharged to obtain a polyester resin that can be used in the present invention.

Exemplary acid components that can be utilized in the preparation of polyester can include without limitation terephthalic acid or a lower alkyl ester compound. The acid component may be used alone, or in any combination thereof, or otherwise may be used in an admixture with a small amount of isophthalic acid, orthophthalic acid, aliphatic dicarboxylic acid, or a lower alkyl ester compound thereof. Exemplary glycol components that can be used in the preparation of polyester can include without limitation ethylene glycol, propylene glycol or butylene glycol. The glycol component may be used alone or in any combination thereof, or otherwise may be used in admixture with a small amount of 1,6-hexane diol or 1,4-cyclohexane dimethanol. Exemplary catalysts that can be utilized in the preparation of polyester can include without limitation oxides of antimony or organotitanium compounds such as tetrabutyl titanate and tetraisopropyl titanate. In addition, organotin compounds may be used alone or may be used in combination with organotitanium compounds. Further, alkali metals or acetate compounds may also be used as the catalyst.

When the organotitanium compound is used as the catalyst, magnesium acetate or lithium acetate may also be used as a cocatalyst.

In addition to the above-mentioned major components and catalysts, minor materials such as an antioxidant, an antistatic agent and various additives may also be used.

The polyester resin suitable for the purpose of the present invention can have an intrinsic viscosity of about 1.25 or higher, for example about 1.3 to about 2, in terms of an intrinsic viscosity.

Using a higher viscosity polyester resin can makes it easier to maintain phase distribution of the overall alloy on a nano scale. It is, however, difficult to synthesize polyester resin having a high viscosity above a given level, using current polymerization methods.

In the present invention, the polyester resin can be used in an amount of about to about 70% by weight.

When the content of the polyester resin is lower than about 20% by weight, this can lead to formation of a discontinuous phase in polycarbonate, which may result in deterioration of fatigue resistance and chemical resistance. On the other hand, when the content of the polyester resin is higher than about 70% by weight, polycarbonate can form a discontinuous phase, which may result in deterioration of impact resistance.

The viscosity of the polyester resin useful in the present invention can be measured using the method for measuring a melt flow rate of a test sample according to ASTM D1238. The melt flow rate measurement is carried out at 250° C. When a weight of 2.16 kg is used, the melt flow rate of the resin does not exceed about 20 g/10 min.

The polyester resin can include without limitation a polyalkylene terephthalate, such as polyethylene terephthalate, polybutylene terephthalate, and the like, polyphenylene terephthalate, copolymers thereof, and the like, as well as combinations thereof.

The impact modifier used in the polymer alloy composition of the present invention may be at least one selected from the group consisting of an olefin copolymer, a core-shell graft copolymer and a mixture thereof.

Examples of the olefin copolymer that can be used in the present invention may include without limitation ethylene/propylene rubber, isoprene rubber, ethylene/octene rubber, ethylene-propylene-diene terpolymer (EPDM), and the like, and combinations thereof. The olefin copolymer may be grafted with about 0.1 to about 5% by weight of at least one reactive functional group selected from maleic anhydride, glycidylmethacrylate, oxazoline, and the like, and combinations thereof, to form a core-shell graft copolymer. Grafting the reactive functional group into the olefin copolymer can be readily practiced by a person having ordinary skill in the art to which the invention pertains.

The impact modifier of the present invention may alternatively be a core-shell graft copolymer, which includes a hard shell formed by grafting of a vinyl monomer into a rubber core. Exemplary core-shell graft copolymers useful in the present invention can be prepared by polymerizing at least one rubber monomer, such as a diene rubber monomer, an acrylate rubber monomer, a silicone rubber monomer, or the like, or a combination thereof, to form a rubber polymer, and grafting the resulting rubber polymer with at least one monomer, such as graftable styrene, alpha-methylstyrene, halogen- or alkyl (such as C₁-C₈ alkyl)-substituted styrene, acrylonitrile, methacrylonitrile, C₁-C₈ methacrylic acid alkyl ester, C₁-C₈ methacrylic acid ester, maleic anhydride, an unsaturated compound such as C₁-C₄ alkyl or phenyl nucleus-substituted maleimide, or the like, or a combination thereof. The content of the rubber can range from about 30 to about 90% by weight.

Examples of the diene rubber may include without limitation butadiene rubber, acrylic rubber, ethylene/propylene rubber, styrene/butadiene rubber, acrylonitrile/butadiene rubber, isoprene rubber, ethylene-propylene-diene terpolymer (EPDM), and the like, and combinations thereof.

The acrylate rubber may include an acrylate monomer such as but not limited to methyl acrylate, ethyl acrylate, n-propyl acrylate, n-butyl acrylate, 2-ethylhexyl acrylate, hexyl methacrylate, 2-ethylhexyl methacrylate, and the like, and combinations thereof. Examples of suitable curing agents used in preparing the copolymer may include without limitation ethylene glycol dimethacrylate, propylene glycol dimethacrylate, 1,3-butylene glycol dimethacrylate, 1,4-butylene glycol dimethacrylate, allyl methacrylate, triallyl cyanurate, and the like, and combinations thereof.

The silicone rubber can be prepared from cyclosiloxane. Examples of the cyclosiloxane may include without limitation hexamethylcyclotrisiloxane, octamethylcyclotetrasiloxane, decamethylcyclopentasiloxane, dodecamethylcyclohexasiloxane, trimethyltriphenylcyclotrisiloxane, tetramethyltetraphenylcyclotetrasiloxane, octaphenylcyclotetrasiloxane, and the like, and combinations thereof.

The silicone rubber can be prepared from at least one of the above-mentioned siloxane materials, using a curing agent. Examples of suitable curing agents may include without limitation trimethoxymethylsilane, triethoxyphenylsilane, tetramethoxysilane, tetraethoxysilane, and the like, and combinations thereof.

The C₁-C₈ methacrylic acid alkyl ester or the C₁-C₈ acrylic acid alkyl ester is an ester of methacrylic acid or acrylic acid, and is prepared from monohydric alcohol containing 1 to 8 carbon atoms.

Examples of these esters may include without limitation methacrylic acid methyl ester, methacrylic acid ethyl ester, methacrylic acid propyl ester, and the like, and combinations thereof.

The impact modifier in the composition of the present invention can be used in an amount of about 0.5 to about 20 parts by weight, based on about 100 parts by weight of the polycarbonate resin and the polyester resin.

When the content of the impact modifier is lower than about 0.5 parts by weight, this may result in insignificant impact modifying effects. On the other hand, when the content of the impact modifier is higher than about 20 parts by weight, this may result in deterioration of mechanical strength such as tensile strength, flexural modulus, and the like.

The polymer alloy composition of the present invention may include other additives in order to extend the use and functionality of the composition. Specific examples of such additives may include without limitation inorganic materials such as glass fibers, carbon fibers, talc, silica, mica and alumina, UV absorbers, thermal stabilizers, light stabilizers, antioxidants, flames retardants, lubricants, dyes and/or pigments, and the like, and combinations thereof.

Addition of the inorganic material to the polymer alloy composition of the present invention can improve physical properties such as mechanical strength and heat distortion temperature.

The resin composition of the present invention can be prepared using known methods for preparing a resin composition. For example, the resin composition can be prepared in the form of pellets by simultaneously mixing constituent components and other additives and subjecting the resulting mixture to melt-extrusion in an extruding machine.

The composition of the present invention can be used for molding of various products and is particularly suitable for manufacturing electric and electronic appliances such as housings of TV sets, computers, mobile communication equipment and office automation equipment, and for use in automotive parts.

In the resin composition of the present invention comprised of the polycarbonate resin, the polyester resin and the impact modifier, the polycarbonate resin and the polyester resin have a phase-separation structure of a size of about 10 to about 200 nm.

Hereinafter, formation of a microstructure having a nano-scale phase and excellent fatigue resistance, impact resistance and chemical resistance via use of the polymer alloy compositions according to embodiments of the present invention will be described in more detail with reference to the following examples. Other matters and details not described herein may be readily understood by those skilled in the art.

### EXAMPLES

Now, the present invention will be described in more detail with reference to the following examples. These examples are provided only for illustrating the present invention and should not be construed as limiting the scope and spirit of the present invention.

### Examples 1 to 4 and Comparative Examples 1 to 5

The polycarbonate resin used in Examples 1 to 4 and Comparative Examples 1 to 5 is Bisphenol A-type linear polycarbonate having a weight-average molecular weight of 25,000 g/mol (PANLITE L-1250WP produced by Teijin Chemicals Ltd., Japan).

The high-viscosity polyester resin used in Examples 1 to 4 is polybutylene terephthalate having specific gravity of 1.32 g/cm³, a melting point of 226° C. and an intrinsic viscosity of 1.30 (TRIBIT 1800S, available from Samyang Corp., Daejeon, Korea), and the medium-viscosity polyester resin used in Comparative Examples 1 to 5 is polybutylene terephthalate having specific gravity of 1.31 g/cm³, a melting point of 226° C. and an intrinsic viscosity of 1.10 (TRIBIT 1700, available from Samyang Corp., Daejeon, Korea).

The core-shell graft copolymer impact modifier used in Examples 1 to 4 and Comparative Examples 1 to 5 is a core-shell graft copolymer (C-223A, available from MRC Co., Japan) in which methacrylic acid methyl ester monomers are grafted into a butadiene core having a weight-average particle diameter of about 0.3 μm.

A specific composition ratio of the components used in Examples 1 to 4 and Comparative Examples 1 to 5 is given in Table 1 below. According to the composition formula of Table 1, the composition components are mixed in a conventional mixer and the mixture is extruded through a twin screw extruder with a bore diameter of 45 mm to prepare the pellets. The resulting resin pellets are dried at 110° C. for more than 3 hours and injection-molded into test specimens using a 10 oz injection molding machine at an injection temperature of 250° C. to 300° C. and at a mold temperature of 30° C. to 60° C.

Prior to preparation of the specimens, the melt flow rate (g/10 min) of the resin pellets is measured according to ASTM D1238 which is a standard test method for the melt flow rates. The melt-flow rate measurement is carried out by measuring the mass of the resin which flows out for 10 min, using a weight of 10 kg at a temperature of 250° C.

In order to measure a length of a flow field which is exhibited by the resin under real injection conditions, an actual flow field length (mm) is measured by maintaining a specimen mold having a thickness of 1 mm at a temperature of 60° C., injection molding the resin in a 10 oz injection molding machine with 95% power and determining a length of the resulting specimen. Table 1 refers to this test as “Actual flow field, Cheil's method.”

TABLE 1

| | | | Examples | | | | Comparative Examples | | | | |
|---|---|---|---|---|---|---|---|---|---|---|---|
| | Components | | 1 | 2 | 3 | 4 | 1 | 2 | 3 | 4 | 5 |
| Composition | Polycarbonate (a) | | 40 | 50 | 50 | 65 | 20 | 40 | 50 | 50 | 90 |
| | High-viscosity polyester | | 60 | 50 | 50 | 35 | 80 | 60 | 50 | — | 10 |
| | resin (b1) | | | | | | | | | | |
| | Medium-viscosity | | — | — | — | — | — | — | — | 50 | — |
| | polyester resin (b2) | | | | | | | | | | |
| | Impact modifier (c) | | 5 | 5 | 10 | 5 | 5 | — | — | 10 | 5 |
| Physical | MFR | ASTM | 23 | 19 | 18 | 17 | 67 | 51 | 43 | 38 | 24 |
| properties | | D1238 | | | | | | | | | |
| | Actual flow | Cheil's | 30 | 25 | 24 | 20 | 36 | 32 | 30 | 28 | 19 |
| | field | method | | | | | | | | | |
| | IZOD ¼″ | ASTM | 50 | 58 | 65 | 59 | 18 | 12 | 13 | 62 | 67 |
| | | D256 | | | | | | | | | |
| | Actual | Before | 0% | 0% | 0% | 0% | 100% | 100% | 100% | 10% | 100% |
| | Impact | coating | | | | | | | | | |
| | Fracture (%) | After | 10% | 0% | 0% | 20% | 100% | 100% | 100% | 20% | 100% |
| | | coating | | | | | | | | | |
| | Fatigue | Before | 140K | 122K | 101K | 95K | 89K | 94K | 73K | 48K | 23K |
| | resistance | coating | | | | | | | | | |
| | | After | 112K | 108K | 97K | 84K | 83K | 89K | 52K | 35K | 11K |
| | | coating | | | | | | | | | |

(Unit: weight part)

Notched Izod Impact Strength (¼″) of the thus-prepared specimen is measured according to a test procedure standard, ASTM D256 (unit: kgf·cm/cm).

A falling dart impact test is carried out in accordance with the standard ASTM D3029 (unit: %) by dropping a weight of 2 kg to the specimens at different heights and then examining fracture behavior of the specimens. Each specimen is tested 20 times and percent fracture thereof is measured.

The test may evaluate ductile fracture and brittle fracture of the specimens. Therefore, evaluation of the fracture behavior of the specimens is divided into ductile fracture and brittle fracture. Brittle fracture (%) is determined by calculating the percent occurrence of the brittle fracture in the total test specimens.

The ductile fracture refers to the state that the test specimen is not cracked but dented by the impact. On the other hand, the brittle fracture means that there is the occurrence of cracks in the specimen.

In order to evaluate fatigue resistance properties of the thus-prepared resin composition, a fatigue failure test is carried out. Fatigue resistance refers to a mechanical property of a sample relating to resistance to repeated application of force onto the sample. The fatigue resistance of the specimen is tested according to the standard, ASTM D638, by repeatedly applying pressure of 4000 psi at 5 times per second onto the tensile specimens along the longitudinal direction until the fatigue fracture occurs. The fatigue resistance of the specimen is expressed by the number of applied impacts that the sample withstood until fatigue fracture occurred.

The falling dart impact test and fatigue resistance test are conducted for samples before and after chemical treatment. The chemical treatment is carried out by solvent dipping of the specimens for 20 sec, using a thinner (product name: “Thinner 276” available from Daihan Bee Chemical Co., Ltd., Kyonggi-Do, Korea). Then, the chemically treated specimens are dried at 70° C. for 5 min.

From the test results of Examples 1 to 4 given in Table 1, it can be seen that alloying the high-viscosity polyester resin and the core-shell graft copolymer impact modifier into the polycarbonate resin leads to high fatigue resistance, impact resistance and chemical resistance, and a significant reduction in a difference of the flow field upon injection at a temperature of 270° C. even though there is a slight decrease of an MI value in terms of the fluidity.

On the other hand, from the test results of Comparative Examples 1 to 5 given in Table 1, it can be seen that alloying the medium-viscosity polyester resin into the polycarbonate resin leads to excellent fluidity and excellent impact resistance prior to coating, but results in lowering of impact resistance and fatigue resistance and significant deterioration of physical properties after coating.

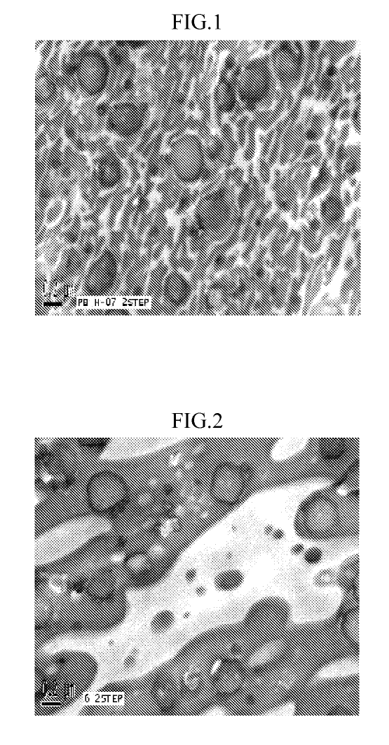

FIGS. 1 and 2 are photographs showing morphological analysis of the resin compositions of Example 3 and Comparative Example 4, respectively, with transmission electron microscopy (TEM). The photographs illustrate the differences between the physical properties of the compositions of Example 3 and Comparative Example 4.

Specimens are prepared of the compositions of Example 3 and Comparative Example 4 prior to the performance of TEM, and the specimens are stained using a two-step staining process using RuO₄ and OsO₄.

The photographs of FIGS. 1 and 2 are taken at the same magnification, for specimens sampled from the same part of the same injection molded articles.

In FIGS. 1 and 2, white parts correspond to the polyester resin, black parts correspond to the polycarbonate resin, and spherical parts correspond to the core-shell graft copolymer.

As shown in the photograph of FIG. 1 for the resin composition of Example 3, the use of the high-viscosity polyester resin leads to nano-scale dispersion of each phase of the polycarbonate and polyester resins and also uniform dispersion of phases, thereby further improving the dispersibility of the core-shell graft copolymer.

Consequently, as indicated in Table 1, the impact resistance and chemical resistance are increased with remarkable improvement of the fatigue resistance.

However, as shown in the photograph of FIG. 2 for the resin composition of Comparative Example 4, the use of the medium-viscosity polyester resin leads to an increase in size of each phase, which consequently results in high susceptibility to strong expression of brittleness unique to the polyester resin, thereby lowering the impact resistance and resulting in poor chemical resistance of a large polycarbonate phase.

In addition, the use of the medium-viscosity polyester resin also leads to deterioration of the fatigue resistance.

Many modifications and other embodiments of the invention will come to mind to one skilled in the art to which this invention pertains having the benefit of the teachings presented in the foregoing descriptions. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation, the scope of the invention being defined in the claims.

That which is claimed is:

1. A polymer alloy composition comprising about 30 to about 80% by weight of a polycarbonate resin, about 20 to about 70% by weight of a polyester resin having an intrinsic viscosity of about 1.2 to about 2, and about 0.5 to about 20 parts by weight of an impact modifier, based on about 100 parts by weight of the polycarbonate resin and the polyester resin.

2. The composition according to claim 1, wherein both the polycarbonate resin and the polyester resin have a phase size ranging from about 10 nanometers (nm) to about 200 nm.

3. The composition according to claim 1, wherein the impact modifier comprises at least one impact modifier selected from the group consisting of reactive olefin copolymers, core-shell graft copolymers and mixtures thereof.

4. The composition according to claim 3, wherein the reactive olefin copolymer comprises ethylene/propylene rubber, isoprene rubber, ethylene/octene rubber, ethylene-propylene-diene terpolymer, or a combination thereof, grafted with at least one reactive functional group selected from maleic anhydride, glycerylmethacrylate, oxazoline, or a combination thereof.

5. The composition according to claim 3, wherein the core-shell graft copolymer is prepared by polymerizing at least one monomer selected from a diene rubber monomer, an acrylate rubber monomer, a silicone rubber monomer, or a combination thereof, to form a rubber polymer, and grafting the resulting rubber polymer with at least one monomer selected from the group consisting of graftable styrene, alpha-methylstyrene, halogen- or alkyl-substituted styrene, acrylonitrile, methacrylonitrile, C₁-C₈ methacrylic acid alkyl ester, C₁-C₈ methacrylic acid alkyl ester, maleic anhydride, C₁-C₄ alkyl or phenyl nucleus-substituted maleimide, and combinations thereof.

6. The composition according to claim 5, wherein the diene rubber comprises at least one diene rubber selected from the group consisting of butadiene rubber, acrylic rubber, ethylene/propylene rubber, styrene/butadiene rubber, acrylonitrile/butadiene rubber, isoprene rubber, ethylene-propylene-diene terpolymer (EPDM), and combinations thereof.

7. The composition according to claim 5, wherein the acrylate rubber is prepared from an acrylate monomer selected from the group consisting of methyl acrylate, ethyl acrylate, n-propyl acrylate, n-butyl acrylate, 2-ethylhexyl acrylate, hexyl methacrylate, 2-ethylhexyl methacrylate, and combinations thereof, using a curing agent.

8. The composition according to claim 5, wherein the silicone rubber is prepared from at least one cyclosiloxane selected from the group consisting of hexamethylcyclotrisiloxane, octamethylcyclotetrasiloxane, decamethylcyclopentasiloxane, dodecamethylcyclohexasiloxane, trimethyltriphenylcyclotrisiloxane, tetramethyltetraphenylcyclotetrasiloxane, octaphenylcyclotetrasiloxane, and combinations thereof.

9. The composition according to claim 5, wherein the C₁-C₈ methacrylic acid alkyl ester or the C₁-C₈ acrylic acid alkyl ester is an ester of methacrylic acid or acrylic acid, and is prepared from monohydric alcohol containing 1 to 8 carbon atoms.

10. The composition according to claim 1, wherein the polyester resin comprises polyalkylene terephthalate, polyphenylene terephthalate or a copolymer or a combination thereof.

11. The composition according to claim 1, further comprising an inorganic material, a thermal stabilizer, an antioxidant, a light stabilizer, a dye, a pigment, or a combination thereof.

12. A molded article produced by using the polymer alloy composition of claim 1.

13. A molded article produced by using the polymer alloy composition of claim 2.

14. A polymer alloy composition comprising a polycarbonate resin, a polyester resin and an impact modifier, wherein the polycarbonate resin and the polyester resin have a phase-separation structure of a size of about 10 to about 200 nm.

15. A molded article produced by using the polymer alloy composition of claim 14.
